(19) United States
(12) Patent Application Publication
(10) Pub. No.: US 2003/0236976 A1
(43) Pub. Date: Dec. 25, 2003

(54) Efficient membership revocation by number

(75) Inventor: Graham A. Wheeler, Redmond, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/174,862

(22) Filed: Jun. 19, 2002

(51) Int. Cl. H04L 9/00

(52) U.S. Cl. 713/158

(57) ABSTRACT

A novel system and method provide a compact representation of revocation information for conserving network bandwidth and member resources in a peer-to-peer network. Group membership certificates are assigned integer serial numbers in a range from a lowest number to a highest number. A certificate revocation list (CRL) is composed of an offset value and a bit vector. The offset value generally describes the lowest currently outstanding serial number, corresponding to the first position in the bit vector. The remaining bit positions of the bit vector represent in order of increasing value the remaining issued certificate serial numbers. The bit corresponding to the serial number of each certificate is set to reflect either a state of “not revoked,” or a state of “revoked.”

### TECHNICAL FIELD

This invention relates generally to the technology of peer-to-peer networking and, more particularly, relates to a system and method for efficiently disseminating revocation status among peer machines.

### BACKGROUND OF THE INVENTION

As computer networks become pervasive in business, education, entertainment, and beyond, the security of such systems increases in vulnerability. For example, a single computer unattached to any network is difficult to maliciously exploit, and indeed illicit access may be had only by physically accessing the computer. However, assuming that other users having computers exist and that such computers are attached at least indirectly to the first machine via a network connection, the possibility of attack or inappropriate access over that network connection arises. Although small groups of users may rely on mutual trust to meet security concerns, such is increasingly unworkable since group size and dispersion is often such today that personal acquaintance with, and resultant trust in, other users is uncommon.

Peer-to-peer networking allows the formation of an often ad hoc network between user machines without requiring the services of a central server. The state of the network is stored on each member machine, and the communications within the network hop from user machine node to user machine node to spread to all recipients. Due to their ad hoc nature, peer-to-peer networks are adaptable to many environments and are hence increasingly useful as an alternative or supplement for server-based networking. However, that same adaptability and flexibility produces administrative issues and vulnerabilities that may not be as prevalent in other network types.

For example, group membership in a peer-to-peer network is often verified through a membership certificate having a expiration lifetime or time-to-live. If a particular member becomes unwelcome during the lifetime of its certificate, a revocation with respect to that member must be disseminated to the members of the peer-to-peer network. This revocation information is generally included in a certificate revocation list (CRL) that is sent periodically, on a scheduled basis or otherwise, to the members of the peer-to-peer network.

Problematically, the transmission of this list throughout the network consumes processing and transmission resources at a level that becomes quite significant when the number of revocations is relatively large. Furthermore, since there is typically no central server supporting the network, each CRL (or the most recent CRL) must be maintained on each member machine, consuming an often significant portion of the resources allocated to the peer-to-peer network. The resources allocatable to a peer-to-peer network on a given machine may be limited in both the number of records that may be stored and the size of each record. Accordingly, much research has been directed towards techniques for reducing the resources required for certificate revocation schemes, and in particular for the transmission and storage of CRLs.

One proposed system does not require the dissemination of CRLs, but does require a member machine to request certificate validation at the time that an attempt is made to exercise an existing certificate. It can bee seen that this technique eliminates the costs associated with sending CRLs that may not be needed, but at the same time it increases the latency incurred and network resources required at the time of attempted access. Another system relies on partial CRL updates instead of sending the entire CRL with each CRL update. In particular, a base CRL is periodically transmitted to the group members, and between such transmissions, delta CRLs are transmitted. The delta CRLs describe the current CRL only by way of changes from the last base CRL transmitted. While this technique tends to minimize the usage of network resources for CRL dissemination, it does not significantly reduce the resources required for each member to store the current CRL.

A system and method of membership revocation are needed whereby the resources required to send and store the revocation information are minimized, allowing for more optimum operation of member machines and of the network as a whole.

### SUMMARY OF THE INVENTION

A novel system and method are described for generating, transmitting, and storing membership certificate revocation information. The group membership certificates are issued having serial numbers that proceed in an integral fashion from a lowest number to a highest number. A highest possible serial number may be established such that certificates issued after the highest serial number has been issued, will be reassigned a lower serial number, starting again from the lowest possible serial number, typically zero (0).

When a certificate is revoked prior to its expiration, a certificate revocation list (CRL) is generated according to an embodiment of the invention. The CRL is composed of an offset value and a bit vector. The offset value describes the lowest currently outstanding serial number, although in an embodiment of the invention the offset value may instead be adjusted to a higher number. The offset value generally accounts for the fact that serial numbers below the offset value are not the subject of the CRL, since whether or not they have been or are being revoked, they are in any case already expired. When the offset value is upwardly adjusted from this value, it will be understood that the numbers between the lowest currently outstanding serial number and the new offset value are neither expired nor revoked.

The bit vector is used by a recipient in combination with the offset value to produce an identification of the certificates that are subject to revocation via the CRL. In particular, each position in the bit vector represents an integral increase in serial number over the immediately adjacent position on one side. As discussed, the first position in the bit vector corresponds in most cases to the lowest currently outstanding serial number as derived from the offset value. The bit corresponding to the serial number of each certificate allows the recipient to determine revocation status, since for a revoked certificate, the bit is set, such as from a state of zero (0), i.e. “not revoked,” to a state of one (1), i.e. “revoked.”

The compact representation of revocation information afforded by embodiments of the invention serves to conserve network bandwidth as well as member resources, since in a peer-to-peer network each member receives and maintains network state information. The compactness in this representation results largely from the preknowledge on the part of both the sender and the recipient that the serial number data is integral and ordered. The invention can provide an additional or complementary mechanism to publishing revocations based on peer-to-peer names. In certain embodiments the network within which the invention is implemented need not be strictly peer-to-peer, and a central server or servers may additionally be used, such as to store network state information and/or to facilitate communications between members. Other features and advantages of various embodiments of the invention will become apparent from the detailed description set forth hereinafter.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an exemplary computer system usable in an implementation of an embodiment of the invention;

FIG. 2 is a network diagram showing an exemplary peer-to-peer networking environment within which an embodiment of the invention may be implemented;

FIG. 3 is a tabular diagram illustrating tables created upon issuance of membership certificates according to an embodiment of the invention;

FIG. 4 is a tabular diagram illustrating certificate revocation list (CRL) representations according to embodiments of the invention; and

FIG. 5 is a flow chart showing steps usable within an embodiment of the invention to create and propagate a certificate revocation list (CRL).

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention is primarily for use in a networked environment and may further be practiced in distributed computing environments where tasks are performed by remote processing devices that are linked through a communications network. In a distributed computing environment, program modules may be located in both local and remote memory storage devices.

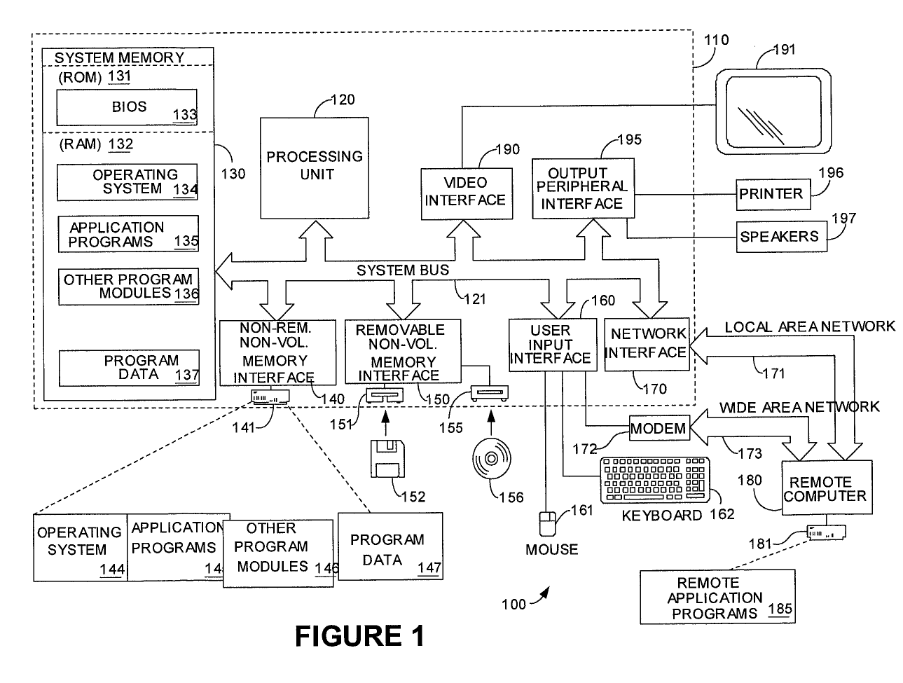

FIG. 1 illustrates an example of a suitable computing system environment 100 usable in an implementation of the invention. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be implemented by way of numerous other general purpose or special purpose computing system environments or configurations. Examples of well known computing systems, environments, and/or configurations that are suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

An exemplary system for implementing the invention includes a general-purpose computing device in the form of a computer 110. Components of the computer 110 generally include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example only, and not limitation, such architectures include Industry Standard Architecture (ISA) bus, Micro Channel Architecture (MCA) bus, Enhanced ISA (EISA) bus, Video Electronics Standards Associate (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example only, and not limitation, computer readable media may comprise computer storage media and communication media.

Computer storage media includes volatile and nonvolatile, removable and nonremovable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics (such as, for example, voltage or current level, voltage or current pulse existence or nonexistence, voltage or current pulse width, voltage or current pulse spacing, etc.) set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates RAM 132 as containing operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a keyboard 162, pointing device 161 (commonly referred to as a mouse), and trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A dedicated monitor 191 or other type of display device may also be connected to the system bus 121 via an interface, such as a video interface 190. In addition to the monitor, computer 110 may also include other peripheral output devices such as speakers 197 and printer 196, which may be connected through an output peripheral interface 195.

In the implementation of an embodiment of the invention, the computer 110 operates in a networked environment using logical connections to one or more remote computers, such as a remote computer 180. The remote computer 180 may be a personal computer, a router, a network PC, a peer device or other common network node, and in any case the remote computer or computers typically include many or all of the elements described above relative to the personal computer 110, although only a memory storage device 181 has been illustrated in FIG. 1, and although in some cases the remote computer can lack much of the functionality contained in the computer 110. The logical connections depicted in FIG. 1 include a local area network (LAN) 171 and a wide area network (WAN) 173, but the computer 110 may additionally or alternatively use one or more other networking environments. Networking environments of all types are commonplace in offices, enterprise-wide computer networks, intranets and the Internet.

The computer 110 should include facilities for accessing the networks to which it is attachable. For example, when used in a LAN networking environment, the personal computer 110 is connected to the LAN 171 through a network interface or adapter 170. Another node on the LAN, such as a proxy server, may be further connected to a WAN such as the Internet. When used in a WAN networking environment, the computer 110 typically includes a modem 172 or other means for establishing communications directly or indirectly over the WAN 173, such as the Internet. The modem 172, which may be internal or external, may be connected to the system bus 121 via the user input interface 160, or other appropriate mechanism.

In a networked environment, program modules depicted relative to the personal computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used. It is not intended to limit the invention to use in a permanent network infrastructure, since it may also be used in transiently connected environments, such as for example a wholly or partially wireless network environment interconnected wholly or partially via optical, infrared, and/or radio frequency wireless connections.

Herein, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

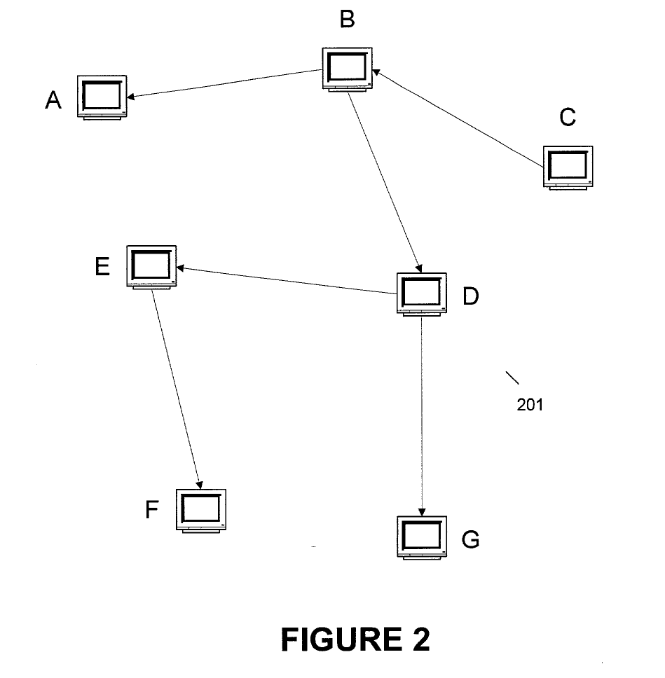

FIG. 2 illustrates schematically a networking environment 201 within which the present invention may be implemented. Member computers A-G are illustrated as belonging to the peer-to-peer network, although it will be appreciated that, generally, existing members may periodically leave the group and other members may periodically join the group. It can bee seen that all members of the group are either directly or indirectly in communication with each other. For example, machines A and B are directly connected to each other, while machines A and C are not directly connected to each other, but may nonetheless communicate via machine B.

Each member A-G of the network 201 attains and maintains membership in the network 201 via a membership certificate or similar structure as will be appreciated by those of skill in the art. Typically, every member will store a membership certificate relative to every other member, or at least those to which it is directly connected, and will allow access from a particular machine as long as that machine's membership certificate remains valid. Each certificate is associated with a lifetime, the expiration of which serves to nullify the validity of the certificate. In addition, certificates may be revoked during their lifetime, and thus may in reality have a shorter effective lifetime than the stated certificate lifetime would imply. Generally, authority to revoke certificates is vested in the creating certifying authority (CA), although such is not required, and other entities may, in an embodiment of the invention, revoke certificates that they did not create.

It will appreciated that since there is no central server provided in the typical peer-to-peer network, the state of the network, i.e. the information usable to identify and locate network members, must be stored in each member machine A-G. Note that while the invention is motivated thus to reduce the storage requirements for membership information, the CRL transmission requirements do not stem from or depend upon the absence of a central server. Accordingly, the invention does not exclude use in environments containing a central server for storing some or all membership information, although such will not be typical.

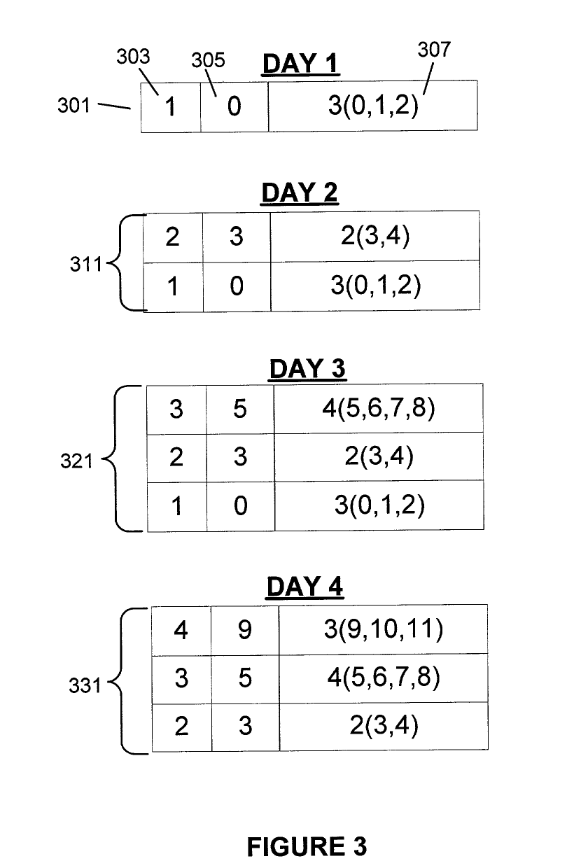

FIG. 3 illustrates in a tabular form the information generated according to an embodiment of the invention during the issuance of certificates. Although it will be assumed that the issuance of certificates and the collection of the relevant information occurs at the certifying authority or authorities, this is not required. Each certificate is associated with a serial number, such that the range of serial numbers extends integrally from zero (0) to the highest number corresponding to the most recently granted certificate. The range of serial numbers is limited such that serial numbers will be reused for assignments made once the highest allowable serial number has been issued. In environments wherein multiple machines (administrators, CAs, etc.) may issue certificates, the CRL information from a particular machine may be associated with an administrator ID. Alternatively the range of available serial numbers may be divided into sub-ranges assigned among the existing administrators so that a particular serial number may be associated with the appropriate issuer by knowing the range assignments. Certificates may have a relatively limited lifetime in one embodiment compared to lifetimes traditionally associated with peer-to-peer certificates. It will be appreciated that a lesser lifetime decreases the resources required to send and maintain certificate state information, but increases the resources required to generate and disseminate new certificates. Thus, it will appreciated that the selection of a lifetime depends upon a number of factors as well as on designer preferences. It will be further appreciated that certificate lifetimes other than three days are also included within the invention, and that the certificate lifetimes need not be uniform across all issued certificates, even from the same issuer.

The examples of FIG. 3 assume a uniform certificate lifetime of three days. An exemplary data structure for maintaining information regarding issued certificates is shown at table 301. The table represents the data accumulated at an issuer on a first day. It can be seen that the day is day 1, as represented in time field 303, and that the first serial number for certificates issued on day will be zero (0), as represented in first serial number field 305. Finally, it can be seen in the issued field 307 that three certificates were issued by the issuer on day 1, having respective serial number of zero (0)(consistent with field 305), one (1), and two (2). Note that it is not required that the number of issued certificates actually be stored expressly, since such can be derived from the list of serial numbers for a particular day, nor is it required that the day be identified expressly, although such is included herein for reader convenience.

Similarly, table 311 shows the state of maintained certificate information on day 2. In particular, it can be seen that two certificates, having serial numbers three (3) and four (4) were issued on day two. Assuming the issuance of 4 certificates on day three, having serial numbers five (5), six (6), seven (7), and eight (8), the network state information is as illustrated in table 321.

Up to this point, the information for all issued certificates has been maintained since the lifetime of the certificates (three days) has not yet expired. However, by the end of day four, the certificates issued on day one will have expired, and hence the information relating to those certificates is no longer maintained. Thus, it can be seen that table 331, as with table 321, contains only three rows, the least recent relating to day 2. Table 331 shows certificates having serial numbers nine (9), ten (10), and eleven (11) were issued on day four.

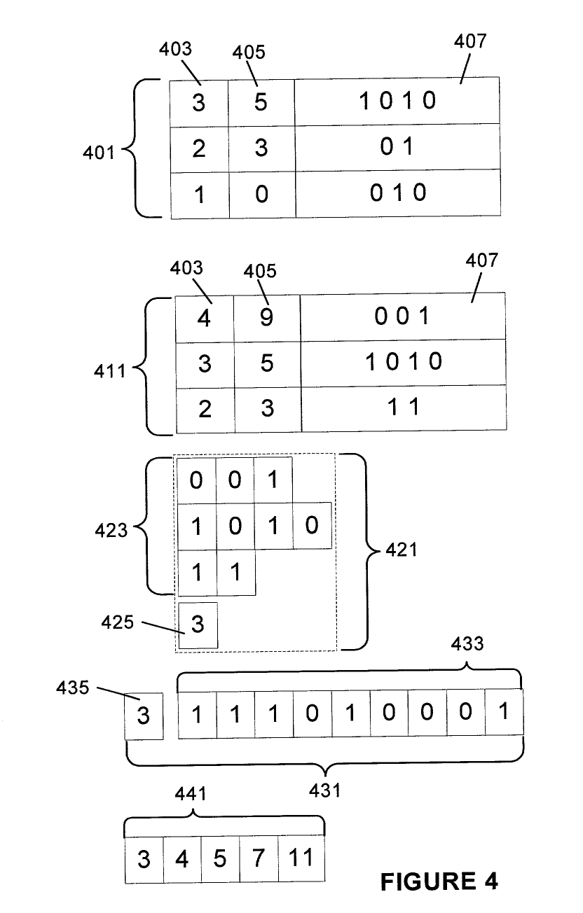

Periodically, one or more members of the network 201 may be removed from the network 201 via revocation. That is, their certificates will be revoked, typically by the certifying authority or authorities that issued them. When this occurs, it will be necessary to change the state of the network as it is stored in a record or records on each member machine. Typically, this entails the transmission of a CRL to each member. Preferably updated CRLs are transmitted to network members each time a revocation is made, and in any case preferably no less frequently than a predetermined frequency such as once per day. FIG. 4 illustrates exemplary CRLs based on the information described by way of FIG. 3. Each CRL uses a bitmap to convey revocations, minimizing the amount of resources required for CRL generation, sending, and storing. In the described embodiment, each bitmap is combinable with an offset value to reconstitute the serial number of the revoked certificate.

Table 401 shows the information of the CRL on day 3. Note that the CRL 401 reflects only the fact of revocation, and does not necessarily reflect the day on which revocation occurred. The lowest unexpired serial number issued on a particular day (field 403) is included in the offset field 405. The bitmap of the bitmap field 407 combines with the entry stored in the offset field 405 for the same day to yield the serial number(s) of any revoked certificate(s). (Again note that the actual day is shown primarily for the reader's convenience, and is not required in all embodiments). It is assumed for the sake of example that certificates bearing serial numbers one (1), four (4), five (5), and seven (7) have been revoked on or before day 3. Thus, the CRL appears as in CRL 401.

Each bit in the bit vectors of bit map field 407 represents an integral increment in the serial number of interest, with the first position indicating a value equal to the offset value of the associated entry in offset field 405. So, for example, the values of the positions in the bit vector associated with day 3 are, from left to right, five (5), six (6), seven (7), and eight (8), while the positions of the bit vector associated with day 2 are, from left to right, three (3) and four (4), and so on. Combining the offset (zero) for day 1 with the bit vector of bit map field 407 yields an indication of revocation for the certificate having serial number of one (1), i.e. 0+1. Similarly, the CRL data associated with day 2 yields an indication of revocation for the certificate having serial number of four (4), i.e. 3+1. Finally, the CRL data associated with day 3 yields an indication of revocation for the certificates having serial numbers five (5) and seven (7), i.e. 5+0 and 5+2.

Note that as discussed above, the revocation of a certificate need not occur on the day it is issued. Thus, the CRL 401, which associates serial number four (4) with day two, does not necessarily indicate that that certificate was indeed revoked on day 2. Thus, referring to CRL 411, corresponding to day four and the two prior days (all certificates from the third day prior have expired if a lifetime of three days is assumed), it can be seen additionally that the certificate with serial number three (3)(i.e. 3+0), issued on day 2, has now been revoked. In addition, the certificate with serial number eleven (11)(i.e. 9+2) issued on day four has also been revoked.

Although the CRLs of FIG. 4 expressly set forth a number of data items associated with each certificate, such is not required. As discussed above, the day identifier of field 403 is not necessary, but is included for reader convenience. Similarly, the offset value of field 405 may be derived from the row number as well as the length of the bit vector for the previous day. Thus, the CRL 411 for day four may be reduced to CRL 421 having an array 423 combined with the offset value 425, which is in this example three (3). Alternatively, the same information may be represented as a single line array 431, having an offset field 435 portion and a revocation ID portion 433. Note that, although not shown, other optimizations can be easily applied. For example, groups of zeros and ones may be compressed and coded as a group as is common in the art of data coding. Furthermore, rows having all unity entries or all zero entries may be compressed. Also, leading zeros (positioned adjacently in the first one or more serial number positions) may be eliminated by simply adjusting the offset value. So for example, two leading zeros can be eliminated and the offset value increased by two.

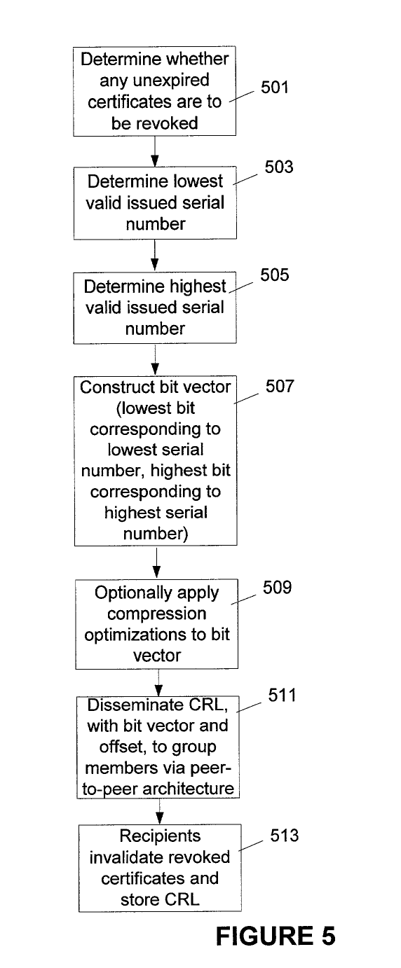

FIG. 5 illustrates an exemplary process for constructing and disseminating a CRL according to an embodiment of the invention. As described above, CRL generation and dissemination take place whenever a revocation is needed, and in any case preferably occur at least once within each cycle of a specified period, such as once per day. Initially, it is determined at step 501 whether any unexpired certificates are to be revoked. This decision may be based on any of a number of factors. Note that a revocation decision as to expired certificates is not needed, since they have already become invalid. At step 503, the lowest unexpired issued serial number is determined, and at step 505 the highest unexpired serial number is determined. In a multiple CA environment, the highest and lowest unexpired serial numbers may be highest and lowest unexpired serial numbers issued by the CA constructing the CRL in question rather than the absolute highest and lowest unexpired serial numbers currently extant, in an embodiment of the invention. Once the highest and lowest currently unexpired serial numbers are determined, a bit vector (or bit map) is constructed in step 507, wherein the lowest position in the bit vector corresponds to the lowest currently unexpired serial number, and the positions of the bit vector increment linearly in integral increments from that point, terminating at a position corresponding to the highest currently unexpired serial number. Additionally, an offset value is set corresponding to the lowest unexpired serial number.

At step 509, compression optimizations are optionally applied to the generated bit vector. Optimizations may include any or all of those described above as well as any other data compression technique usable to minimize the amount of data needed to convey the CRL. For example, delta encoding may be used to further decrease the amount of data required. The generated CRL, which includes the bit vector and offset value, and which also may include certificate administrator identification information, is disseminated to the members of the group in step 511 via the peer-to-peer architecture as described above. Note that the issuing CA may be identified within the CRL itself, or instead in the transmission in which the CRL is sent.

Upon receiving the CRL, each group member interprets the CRL and invalidates its copy of any revoked certificates, and stores the CRL for reference with respect to future communications from other machines in step 513. The recipients may store the CRL in the compact from in which it was sent, or may alternatively expand the information out slightly so that no further computations are necessary to identify revoked certificates. For example, the array 431 could be stored as a list of revoked serial numbers as in listing 441.

The process of interpreting the CRL is as follows in an embodiment of the invention. The recipient first identifies bit positions of any set bits in the bit vector. Next, each such bit position is associated with its corresponding peer-to-peer network membership certificate. Finally, the affected peer-to-peer network membership certificates are invalidated.

Note that storing the CRL may occur differently in different circumstances. For example, if a complete CRL is sent at every update, then the prior CRL is entirely removed from memory and replaced with the newest one. If on the other the CRL update takes the form of a delta update, describing only the changes from a prior base CRL, then the existing CRL in memory is modified accordingly to produce a complete replica of the latest CRL.

As discussed above, the techniques described herein generalize easily to the situation of multiple certificate issuers, or administrators. Two primary issues are administrator identification and revocation permissions. Typically, the administrator identification should be included within or accompany the CRL so that permissions, authenticity and so forth may be checked. With respect to revocation permission, it is assumed, but not required, that an issuing administrator may revoke at least the certificates that it issued. As a policy matter, it may be undesirable to extend revocation permission to allow revocation of certificates issued by other administrators. However, if such is allowed, care should be taken to have a policy in place for resolving contentions. While any such policy may be used in this capacity, one exemplary policy is to allow actions by the issuing authority to override contradictory actions of others with respect to the affected certificate.

While a novel technique and system for membership revocation by serial number have been described herein by way of example, it will be appreciated that the scope of the invention extends beyond the details of the given examples. That is, in view of the many possible embodiments to which the principles of this invention may be applied, it should be recognized that the embodiments described herein with respect to the drawing figures are meant to be illustrative only and should not be taken as limiting the scope of invention. Those of skill in the art will recognize that the elements of the illustrated embodiments shown in software may be implemented in hardware and vice versa or that the illustrated embodiments can be modified in arrangement and detail without departing from the spirit of the invention.

Moreover, although a certificate lifetime of three days is used in the examples described herein, the salient feature of the lifetime is not its exact value, but rather the fact that it has a known maximum, so that the CRL bit vector has a known maximum size. Furthermore, as made clear above, it is not required that every certificate, even those issuing from the same CA, have an identical lifetime. It will be appreciated that some certificates may possess longer lifetimes than others for a variety of reasons. Additionally, although revocation has been described as generally issuing from the CA that originally issued the certificate in question, such is not required in every embodiment of the invention. Therefore, the invention as described herein contemplates all such embodiments as may come within the scope of the following claims and equivalents thereof.

All of the references cited herein, including patents, patent applications, and publications, are hereby incorporated in their entireties by reference. That is, each and every part of every such reference is considered to be part of this disclosure, and therefore no part of any such reference is excluded by this statement or by any other statement in this disclosure from being a part of this disclosure.

We claim:

1. A method of compactly representing membership certificate validity information in a network environment having network members wherein network membership is imparted by a valid membership certificate having a serial number, the method comprising:
determining that an existing valid membership certificate is to be invalidated;
constructing a bit vector, wherein the bit vector comprises bit positions, each bit position except the first representing a membership certificate serial number one greater than a serial number represented by an adjacent prior bit position; and
determining at least one offset value such that the at least one offset value in combination with the bit vector determines the serial number of the existing valid membership certificate to be invalidated.

2. The method according to claim 1, wherein each bit position of the bit vector has a state selected from the group consisting of set and unset, whereby a bit position in a set state indicates invalidation of the membership certificate corresponding to the serial number associated with the bit position.

3. The method according to claim 1, wherein each membership certificate is associated with a lifetime after which the membership certificate is expired, and wherein one of the at least one offset value corresponds to a lowest serial number currently associated with an unexpired membership certificate.

4. The method according to claim 1, wherein the at least one offset value corresponds to the lowest serial number associated with an unexpired membership certificate that is invalidated.

5. The method according to claim 1, wherein the offset value in combination with the bit vector identifies the serial numbers of a plurality of existing valid membership certificates to be invalidated.

6. The method according to claim 1, wherein each membership certificate has a lifetime such that the group of all memberships is associated with at least one lifetime, and wherein the size of the bit vector is monotonically related to the length of the at least one lifetime.

7. A method of constructing a revocation list for identifying a particular network group membership to be revoked, the method comprising:
ascertaining a numerical membership identifier associated with the particular network group membership, wherein the membership identifier is an integer;
identifying a lowest numerical membership identifier associated with any currently unexpired network group membership and identifying a highest numerical membership identifier associated with any currently unexpired network group membership, wherein each group membership is associated with a group lifetime after which the group membership is expired;
constructing a bit vector having bit positions representing membership identifiers between and including the highest and lowest membership identifiers, wherein a bit in the bit position corresponding to the membership identifier of the particular network group membership to be revoked is set; and
resolving a start value that identifies a membership identifier associated with a bit position in the bit vector, whereby the bit vector and start value together comprise a revocation list from which the membership identifier of the particular network group membership to be revoked can be established.

8. The method according to claim 7, further comprising compressing the revocation list.

9. The method according to claim 8, wherein compressing the revocation list comprises performing at least one optimization selected from the group consisting of:
coding strings of adjacent zeroes in the bit vector;
coding strings of adjacent ones in the bit vector; and
eliminating at least one leading zero from the bit vector and adjusting the start value accordingly.

10. The method according to claim 7, wherein the start value corresponds to the lowest numerical membership identifier associated with an unexpired network group membership to be revoked.

11. The method according to claim 7, wherein the bit vector and start value together distinguish the membership identifiers of a plurality of network group memberships to be revoked.

12. The method according to claim 7, wherein the size of the bit vector is monotonically related to the length of the group lifetime.

13. The method according to claim 7, wherein currently unexpired group memberships have been issued by a plurality of issuing authorities, and wherein the particular network group membership to be revoked was issued by a first issuing authority, further comprising appending an identifier of the first issuing authority to the revocation list.

14. The method according to claim 7, wherein the network environment comprises a peer-to-peer environment.

15. A peer-to-peer networking group membership certificate revocation list comprising:
a bit vector comprised of a series of bits, each bit representing a bit number differing by a predetermined difference from a bit number represented by an adjacent bit, the series of bits thus representing a monotonic progression of bit numbers, each particular bit number being associated uniquely with a particular peer-to-peer networking group membership certificate, and each bit having a state selected from the group consisting of a set state and an unset state; and
an offset value that identifies the bit number associated with one bit in the series of bits, and that is usable to identify at least indirectly the bit number associated with each other bit in the bit vector, whereby a peer-to-peer networking group membership certificate associated with a set bit state is identified and revoked.

16. A method of invalidating a peer-to-peer network membership certificate comprising;
receiving a certificate revocation list, wherein the list comprises a bit vector and an offset value, wherein each bit position in the bit vector is associated with a peer-to-peer network membership certificate;
identifying a bit position of a set bit in the bit vector;
associating the bit position of the set bit with a particular peer-to-peer network membership certificate associated with the bit position; and
invalidating the particular peer-to-peer network membership certificate.

17. A computer-readable medium having thereon computer-readable instructions for compactly representing membership certificate validity information in a network environment having network members wherein network membership is imparted by a valid membership certificate having a serial number, by performing steps comprising:
determining that an existing valid membership certificate is to be invalidated;
constructing a bit vector, wherein the bit vector comprises bit positions, each bit position except the first representing a membership certificate serial number one greater than a serial number represented by an adjacent prior bit position; and
determining an offset value such that the offset value in combination with the bit vector determines the serial number of the existing valid membership certificate to be invalidated.

18. A computer-readable medium having thereon a data-structure forming a compact representation of a certificate revocation list for use in revoking group membership certificates in a peer-to-peer network, the data structure comprising:
a bit array having a plurality of bit positions, each having a bit value that may be either a first value or a second value, each bit position having a bit position number associated with a group certificate, wherein the first value indicates validity of the group certificate associated with the affected bit position number and the second value indicates revocation of the group certificate associated with the affected bit position number; and
an offset field for storing an offset value indicative of the bit position number of the first bit position in the bit array, whereby the bit position numbers of the remaining bit positions in the bit array may be identified.

19. The computer-readable medium according to claim 20, wherein the data structure further comprises an identifier of a certifying authority that constructed the data structure.

20. The computer-readable medium according to claim 20, wherein the bit value of at least one of the bit positions has the second value, indicating that the certificate associated with the at least one bit position is to be invalidated.
